(19) United States
(12) Patent Application Publication
(10) Pub. No.: US 2005/0198229 A1
(43) Pub. Date: Sep. 8, 2005

(54) Methods, systems, and computer program products for template-based network element management

(76) Inventor: Allan Casteel, Maylene, AL (US)

Correspondence Address: Rohan G. Sabapathypillai;Myers Bigel Sibley & Sajovec, P.A., P.O. Box 37428, Raleigh, NC, 27627, US

(21) Appl. No.: 10/744,525

(22) Filed: Dec. 23, 2003

(51) Int. Cl. G06F 15/177

(52) U.S. Cl. 709/221; 709/220

(57) ABSTRACT

A communications network is managed by providing templates relating to network elements that contain fields and predefined values for the fields. User selection of the fields and predefined values is allowed in order to manage the network elements. The network may also be updated based on the user selection of the fields and predefined values. Related systems and computer program products are also discussed.

### FIELD OF THE INVENTION

This invention relates to communication networks, and more specifically to methods, systems, and computer program products for managing network elements in communications networks.

### BACKGROUND OF THE INVENTION

Communications networks, such as telecommunications networks, may include thousands of different network elements of various types and made by different manufacturers. For example, as shown in FIG. 1, a conventional communications network 100 can include up to thousands or more network elements, such as network elements 120a . . . 120n. Network elements 120a . . . 120n may include servers 120a, routers 120b, switches 120c, probes 120d, and/or other equipment. Fewer or more elements than are illustrated in FIG. 1 may be provided. The design and operation of the communications network 100 and the network elements 120a . . . 120n are well known to those having skill in the art and need not be described further herein.

Element management systems, methods, and computer program products are widely used in communications networks to manage these network elements. The element management systems, methods, and computer program products can provide information regarding the status and operation of network elements from each element to a network management center via a network management protocol. Well-known network management protocols include Simple Network Management Protocol (SNMP) and Common Management Information Protocol (CMIP). The element management systems, methods, and computer program products thereby may allow for control and configuration of the network elements by remote access, away from the physical location of the individual elements.

One example of element management is Script Commander, used internally by BellSouth, Inc. Script Commander is a graphical interface that enables users to remotely manipulate and/or configure network devices without knowledge of Unix and/or Vi editing. Script Commander is described in the presentation entitled “Script Commander,” presented to BellSouth, Inc. by the present inventor in February 1998.

### SUMMARY OF THE INVENTION

Some embodiments of the present invention provide methods for managing a communications network that includes a plurality of communications network elements. According to some embodiments of the present invention, methods of communications network element management may include providing templates that relate to the plurality of communications network elements. The templates may include a plurality of template fields and a plurality of predefined values for at least some of the fields. User selection of the fields and predefined values may be allowed in order to manage the communications network elements.

In other embodiments of the present invention, methods of element management may also include updating the communications network based on the user selection of the fields and predefined values. Updating the communications network may include documenting changes to the fields and predefined values based on the user selection, and distributing the changes to the communications network. Updating the communications network may also include configuring the network elements based on the user selection of the fields and predefined values.

In some embodiments, the fields and predefined values of the templates may provide system information for the communications network elements. The system information may include information about element status, software version, and/or vendor information. In other embodiments, the fields and predefined values of the templates may provide interface information for the communications network elements. The interface information may include information about IP address, IP mask, port speed, and/or port status. In some embodiments, the fields and predefined values may provide contact information for the communications network elements, and, in other embodiments, the fields and predefined values may provide identification information.

According to other embodiments of the present invention, allowing user selection of the fields and values of the templates may include allowing user editing of the fields and predefined values. In other embodiments, allowing user selection of the fields and predefined values may include allowing user searching of the templates in the communications network. In some embodiments, allowing user selection may include preventing multiple users from simultaneously accessing a template. In other embodiments, allowing user selection may include tracking user changes to the fields and predefined values of the templates.

In some embodiments, methods of element management may also include archiving current versions of the templates including the fields and predefined values. In other embodiments, allowing user selection of the fields and predefined values of the templates may include allowing user customization of the templates to define new fields and predefined values. Allowing user customization may include allowing user commentary, and/or allowing users to add sub-templates to the templates. The sub-templates may also include fields and predefined values for the fields.

According to some embodiments of the present invention, allowing user selection of the fields and predefined values of the templates may include displaying the communications network elements in a matrix, allowing user selection of the communications network elements from the matrix, and allowing user selection of the fields and predefined values based on the user selection of the communications network elements.

It will be understood that, although embodiments of the present invention have been described above primarily with respect to methods of template-based network element management, other embodiments can provide analogous systems, computer program products, and/or the templates themselves. Other systems, methods, computer program products, and/or templates according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 illustrates a conventional communications network.

FIG. 2 illustrates template-based network element management according to embodiments of the present invention.

FIG. 3 illustrates template-based network element management according to further embodiments of the present invention.

FIG. 4 is a block diagram of template-based element management servers according to embodiments of the present invention.

FIG. 5 is a block diagram of file managers according to embodiments of the present invention.

FIGS. 6-10 are flowcharts of operations that may be performed for network element management according to embodiments of the present invention.

FIGS. 11-13 are flowcharts of operations that may be performed by template-based element management servers and file managers according to embodiments of the present invention.

FIGS. 14 and 15 are examples of user interfaces according to embodiments of the present invention.

FIGS. 16-20 are examples of templates according to various embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams and/or flowchart illustrations of methods, systems and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

As will be appreciated by one of skill in the art, the present invention may be embodied as a method, system, computer program product, and/or template. Thus, the present invention may take the form of an entirely hardware embodiment, an entirely software embodiment or an embodiment combining software and hardware aspects, which may be collectively referred to herein as a “module”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

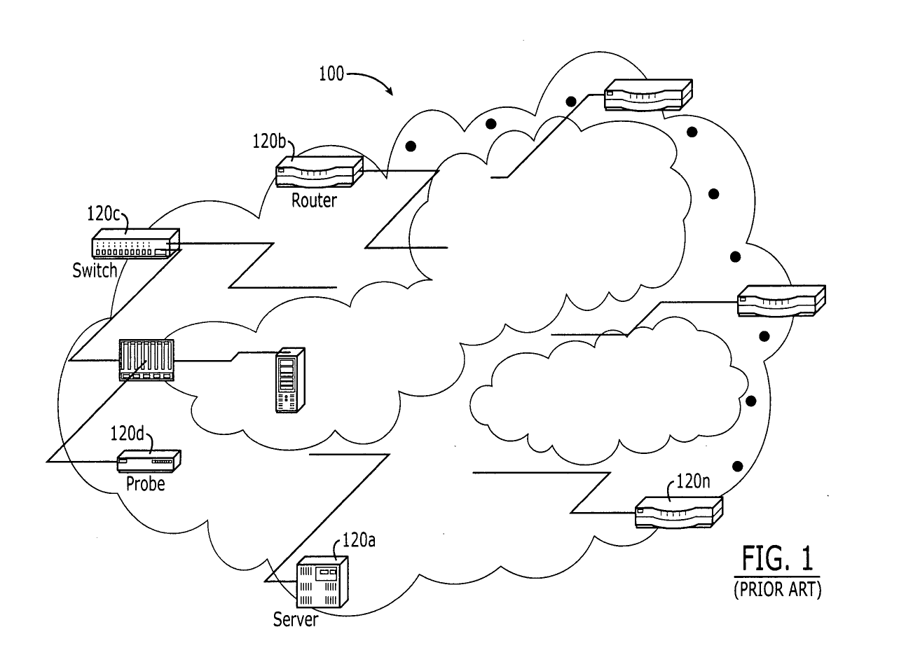

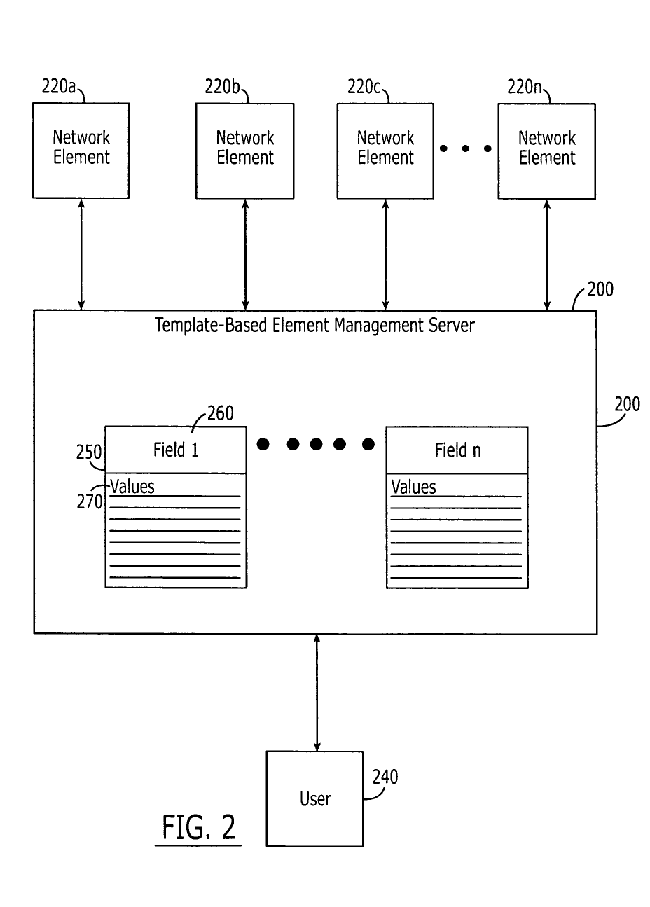

FIG. 2 illustrates template-based network element management according to some embodiments of the present invention. As shown in FIG. 2, a template-based element management server 200 is connected to network elements 220a . . . 220n and a user 240. The user 240 may be a human user at a user terminal, such as a workstation, and/or another computer system that obtains information from the server 200. The connection may be direct and/or through a communications network. The network may be public and/or private, wired and/or wireless, and/or may include the World Wide Web. The server 200, network elements 220a . . . 220n, and user 240 may be distributed throughout a network, and/or may be centrally located. The user 240 and the server 200 may have a client/server relationship and/or may be at the same location. The network elements 220a . . . 220n may correspond to the network elements 120a . . . 120n of FIG. 1. The element management server 200 provides the user 240 with templates 250 which have fields 260 and predefined values 270 relating to the network elements 220a . . . 220n. The template-based element management server 200 communicates with the network elements 220a . . . 220n, and the user 240 may access and/or configure the network elements 220a . . . 220n by communication with the element management server 200.

Conventionally, configuration changes and/or other information for network elements may be documented in text files. Some embodiments of the present invention may arise from a realization that access and formatting for these text files may be uncontrolled. Access may frequently be provided through an open Network File System (NFS) protocol, meaning that any users with such capability can modify, copy move, and/or delete files. Further, the formats for the text files may be unspecified, resulting in different file formats being saved to the servers and making searching more difficult. As such, information regarding the status and configuration of specific network elements may be incorrect, incomplete, out of date, unavailable, and/or difficult to find. In contrast, embodiments of the present invention can provide templates with fields and predefined values that can allow uniform input and control of network element information with a limited number of options. Improved network management thereby may be provided.

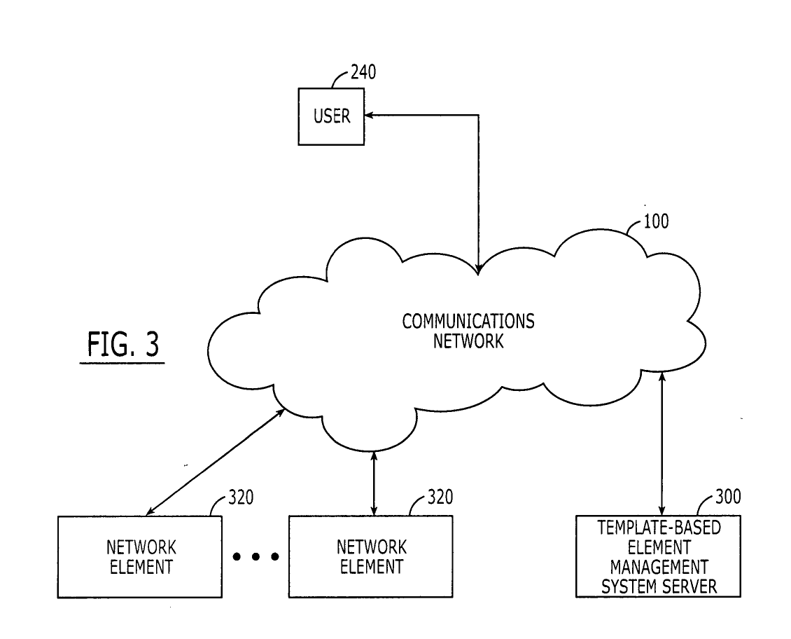

FIG. 3 illustrates template-based network management according to further embodiments of the present invention. As shown in FIG. 3, a template-based element management server 300 is connected to a network element 320 through the communications network 100. The network element 320 and the server 300 may correspond to one of the network elements 220a . . . 220n and the server 200 of FIG. 2, respectively. The template-based element management server 300 communicates with the network element 320 via a network protocol, such as SNMP. A user 240 connected to the element management server 300 through the network 100 may thereby access and/or configure the network element 320 remotely.

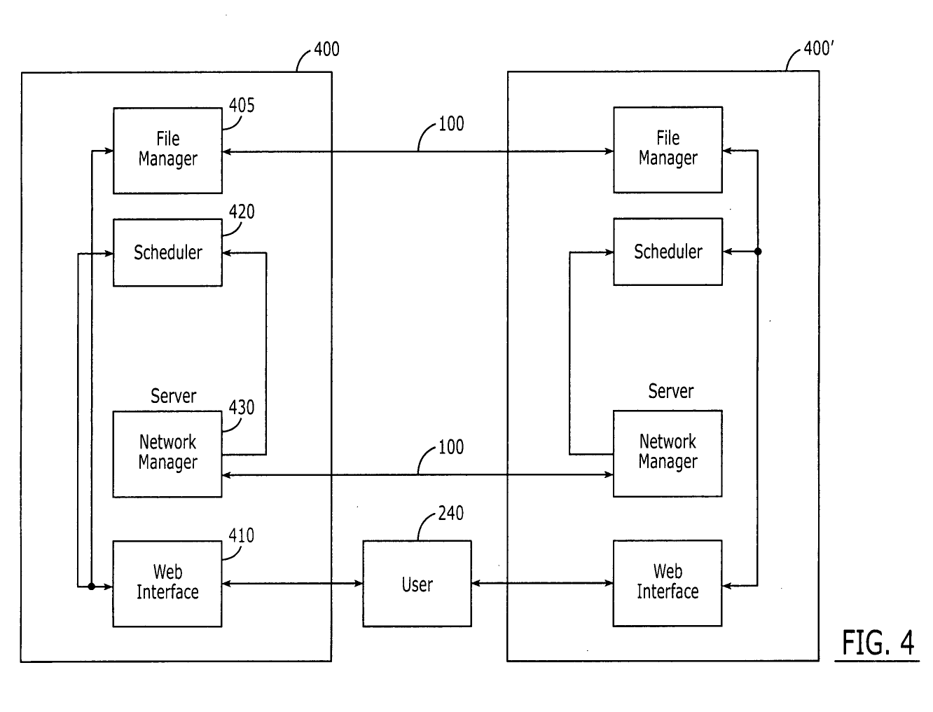

FIG. 4 is a block diagram of a distributed template-based element management server according to embodiments of the present invention, which may correspond to the server 300 of FIG. 3. The template-based element management servers may be connected through the communications network 100. As shown in FIG. 3, the local template-based element management server 400 includes a file manager 405, a web interface 410, a scheduler 420, and a network manager 430. The file manager 405 controls access to templates which contain information about the status and operation of the network elements. The file manager 405 also synchronizes and distributes information between the local template-based element management server 400 and remote template-based element management servers 400′ in the network. The network manager 430 discovers and polls the network elements to determine if they are functioning properly, and if not, to determine the nature and severity of any problems. The scheduler 420 launches commands from the network manager at specified time intervals. The Web interface 410 allows users 240 to access and edit the templates stored in the file manager 405 using a Web browser.

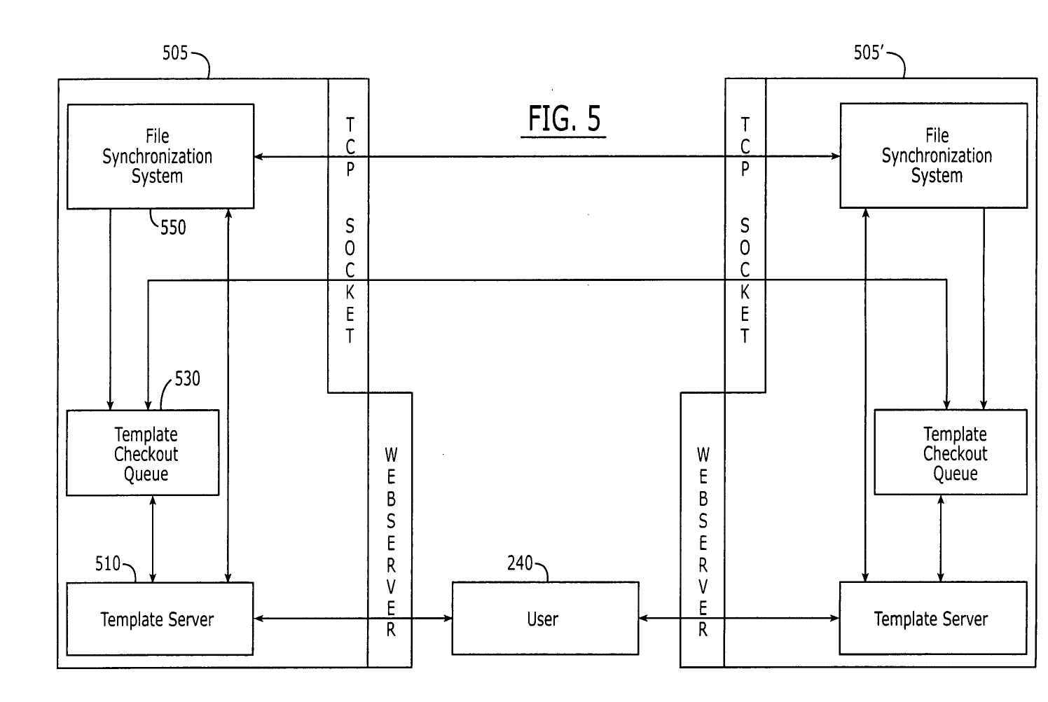

FIG. 5 is a block diagram of a file manager according to embodiments of the present invention, which may correspond to file manager 405 of FIG. 4. Referring to FIG. 5, a local file manager 505 includes a template server 510, which stores templates that contain information relating to each network element. The templates define fields and values for accessing and configuring the network elements. The templates may represent text files stored using XML markup codes, and/or may be provided in XSL format. The template server 510 is connected to a template checkout queue 530 and a file synchronization system 550. The checkout queue 530 and the file synchronization system 550 can distribute information to remote file managers 505′ in the remote template-based element management servers 400′ of FIG. 4.

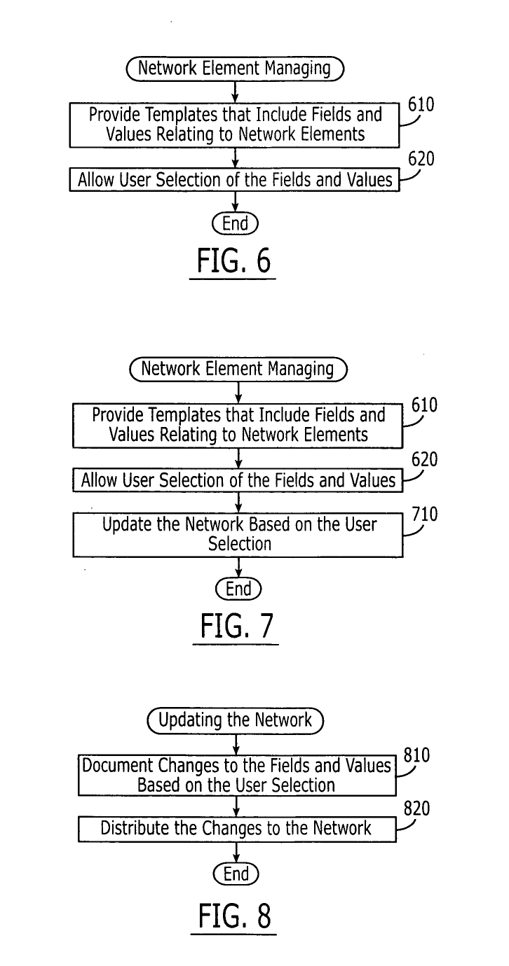

FIG. 6 is a flowchart that illustrates operations for template-based network element management according to embodiments of the present invention. Referring to FIG. 6, templates that include fields and predefined values relating to network elements are provided at Block 610. The templates, fields, and predefined values may respectively correspond to the templates 250, fields 260, and predefined values 270 of FIG. 2. A file manager, such as the file manager 405 of FIG. 4, may be implemented to provide these templates. At Block 620, user selection of the fields and predefined values relating to the network elements is allowed in order to manage the network elements. A web interface, such as the web interface 410 of FIG. 4, may be implemented to allow the above user selection.

FIG. 7 is a flowchart illustrating further operations according to the embodiments of FIG. 6. Referring to Block 710 of FIG. 7, the network is updated based on the user selection of the fields and predefined values in Block 620 of FIG. 6. A file manager, such as the file manager 505 of FIG. 5, may be responsible for such updates.

FIG. 8 is a flowchart that illustrates operations for updating the network according to embodiments of the present invention, which may correspond to Block 710 of FIG. 7. As shown in Block 810 of FIG. 8, updating the network includes documenting changes to the template fields and predefined values based on the user selection in Block 620 of FIG. 6. The changes are then distributed to the network at Block 820. A file synchronization system, such as the file synchronization system 550 of FIG. 5, may be responsible for the above distribution.

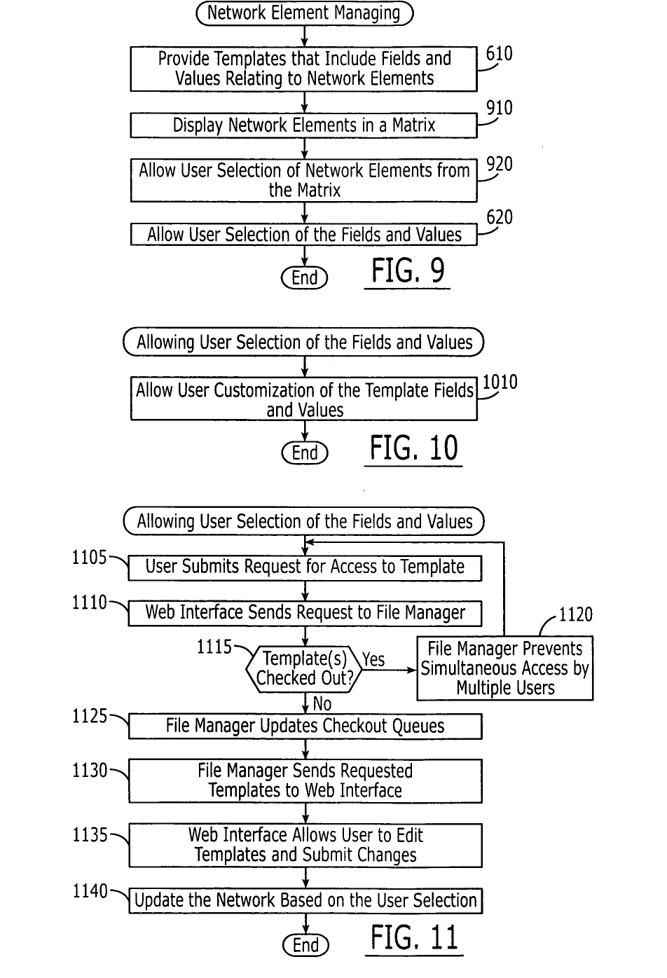

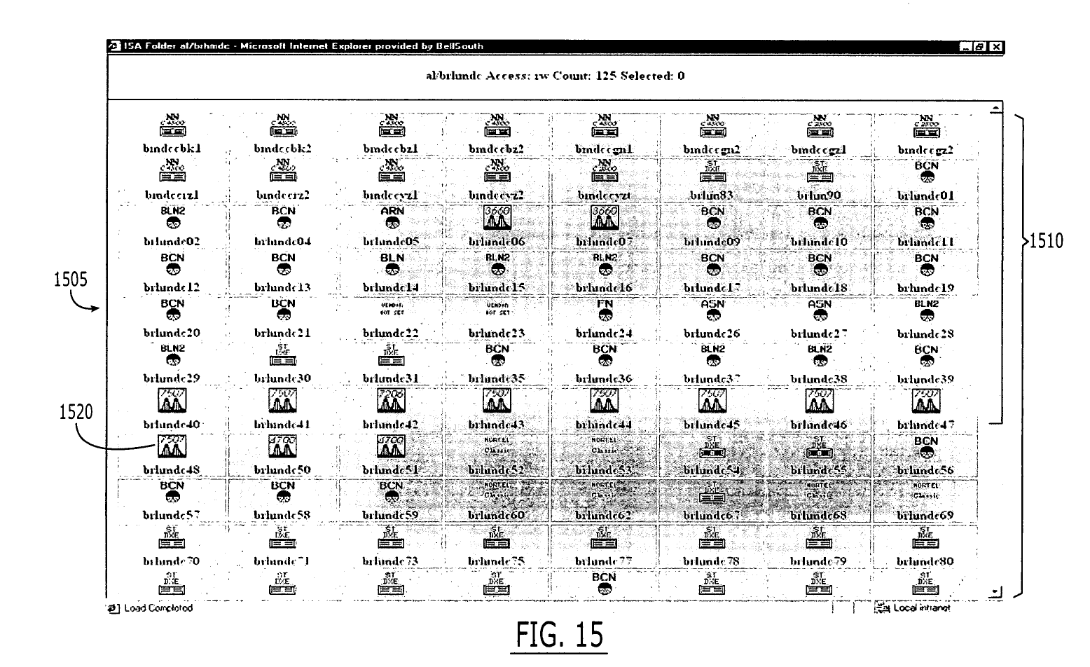

FIG. 9 is a flowchart showing operations for template-based network element management according to further embodiments of the present invention. Referring to FIG. 9, templates that include fields and predefined values relating to network elements are provided at Block 610. The network elements are then displayed in a matrix at Block 910. At Block 920, user selection of network elements from the matrix is allowed. Then, at Block 620, a user is allowed to select from template fields and values relating to the network elements selected at Block 920, in order to manage the selected network elements. An example of the above matrix is shown in FIG. 15.

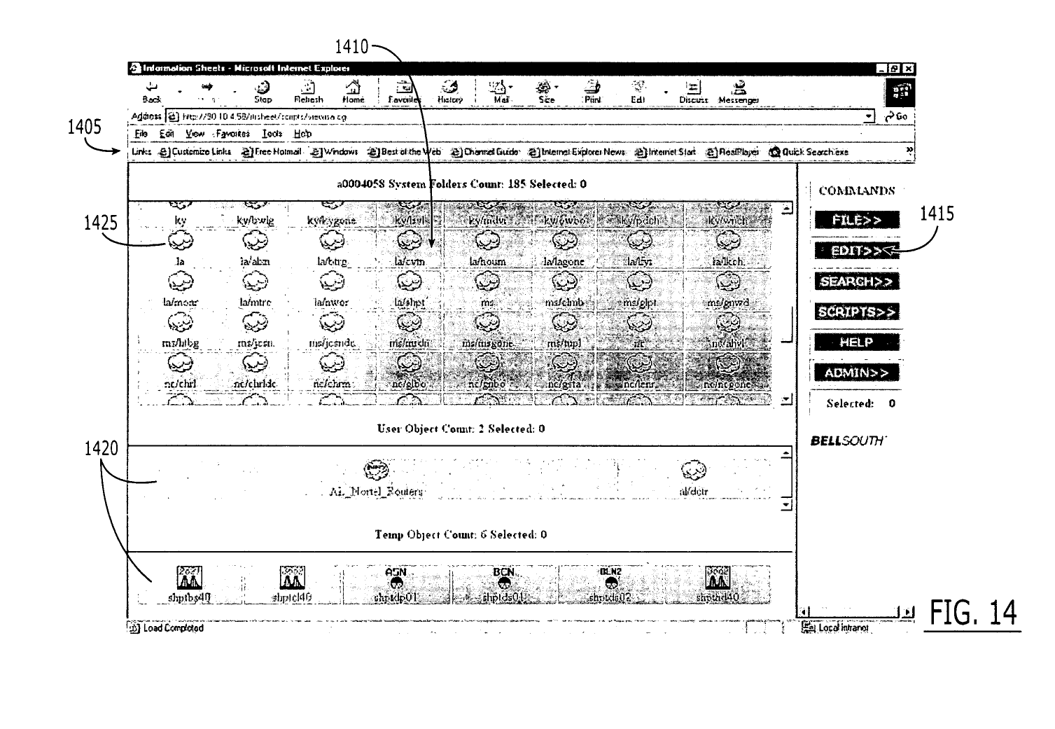

FIG. 10 is a flowchart that illustrates further operations for allowing user selection of the template fields and values according to embodiments of the present invention, which may correspond to Block 620 of FIG. 6. As shown in FIG. 10, allowing user selection includes allowing user customization of the fields and values of the templates relating to the network elements at Block 1010. Users may customize the template by creating their own fields and/or sub-templates and adding them to the template. Users may also customize the template by adding user commentary regarding changes to the fields and values of the template. Examples of such user customization are shown in FIGS. 14, 16, and 20.

Operations of a template-based element management system according to embodiments of the present invention, which may be performed by elements illustrated in FIGS. 2, 3, 4, and 5, will now be discussed with reference to the flowcharts of FIGS. 11, 12, and 13.

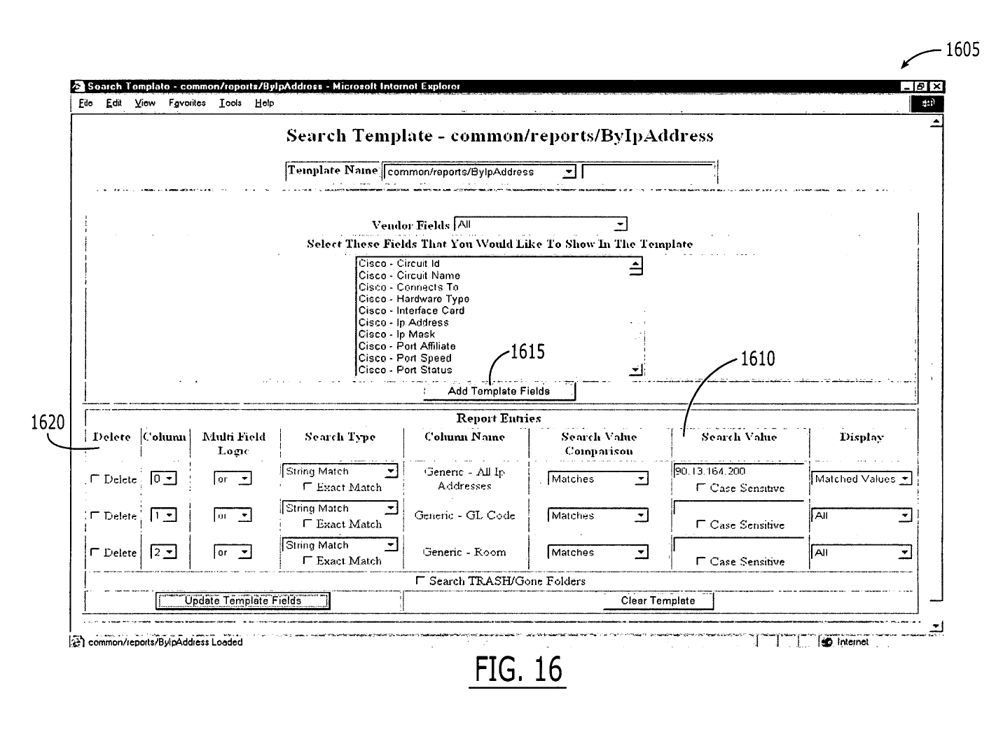

FIG. 11 is a flowchart illustrating operations for allowing user selection of template fields and values, which may correspond to Block 620 of FIG. 6. As shown in FIG. 11, a user 240 submits a request to a template-based element management server 400 for access to a template 250 for a network element 320 via a web interface 410 at Block 1105. The user 240 may be required to enter a user ID and a password in order to access the element management server 400. The user 240 may also simultaneously submit requests to access multiple templates. The web interface 410 may display the network elements in a matrix, and the user 240 may submit a request to access the fields 260 and values 270 of a template 250 based on a selection from the matrix, as shown in FIG. 15. The user 240 may also perform a search of the network elements, and submit a request for access based on the results of the search. An example of a search template is illustrated in FIG. 16.

At Block 1110, the web interface 410 sends the request for access to a file manager 505 in the element management server 400. Upon receiving the request at Block 1115, the file manager 505 checks a checkout queue 530 to determine whether the template 250 that relates to the selected network element 320 is currently in use by another user. The file manager 505 may determine which template is desired by the user 240 based upon vendor and chassis information for the selected network element. The file manager 505 also checks the checkout queues of remote file managers 505′ in the remote element management servers 400′. If the template 250 is in use, the file manager 505 prevents multiple users from simultaneously accessing the fields 260 and values 270 of the template 250 at Block 1120. For example, the file manager 505 may send the user 240 a message via the web interface 410 that the requested template 250 is checked-out. The message may include the name, phone number, and e-mail address of the user that is currently accessing the template 250.

Still referring to FIG. 11, if the template 250 is not in use, the file manager 505 adds information identifying the user 240 to update the checkout queue 530 at Block 1125. This information is also distributed to the checkout queues of the remote file managers 505′ in the remote element management servers 400′. The file manager 505 then sends the requested template 250 from the template server 510 to the web interface 410 and logs the transaction at Block 1130.

At Block 1135 of FIG. 11, the web interface 410 allows the user 240 to edit and submit changes to the template 250. The web interface 410 formats the display based on the template 250, defining the fields 260 and values 270 which the user 240 may edit for the network element 320. The template 250 may be formatted such that a general information template exists for all files. A vendor specific template may also be provided for each product class. Alternatively, the template 250 may include both general and vendor specific sub-templates. Fields of the template 250 may include contact information and identification information for the selected network element 320. System and interface information, such as element status, vendor, software version, IP address, IP mask, port speed, and port status, may also be included in the template 250. In addition, the template 250 may include fields for user commentary regarding changes to template and/or element configuration. The user 240 may also customize the fields 260 and values 270 of the template 250 according to his preferences. Once the user 240 has finished editing the templates, the user 240 submits the templates to the file manager 505 via the web interface 410 with a request to save. The network is then updated at Block 1140, which may correspond to Block 710 of FIG. 7.

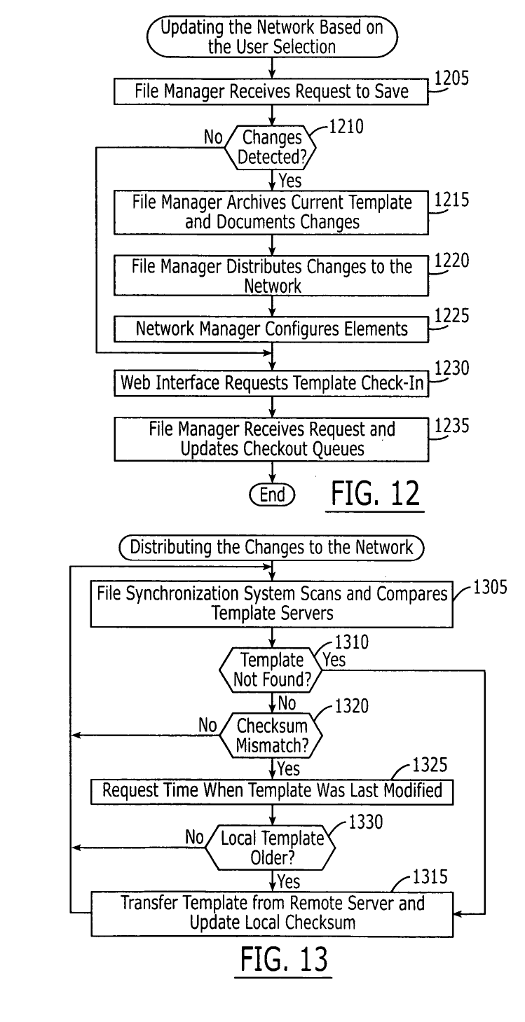

FIG. 12 is a flowchart illustrating operations for updating the network, which may correspond to Block 710 of FIG. 7. Referring now to FIG. 12, the file manager 505 receives the request to save from the user 240 at Block 1205. The file manager 505 then checks for changes to the template 250, based on a checksum of the existing template in the template server 510 at Block 1210. If changes are detected, the file manager 505 archives the existing version of the template as a backup copy, and then saves the newly submitted fields 260 and values 270 as the current version in the template server 410 at Block 1215. Changes may be documented in an audit trail for the template. At Block 1220, the file manager 505 distributes the changes to the remote element management servers 400′ in the network via a file synchronization system 550. This allows users to track changes made to the template 250, even if done at different locations in the network. The file manager 505 may log the transaction by user identity and send a message to the user 240 via the web interface 410 that changes have been saved. At Block 1225, the network manager 430 configures the network element 320 based on the changes to the template fields 260 and values 270 entered by the user 240. Users may thereby manage the network elements by making changes to the templates.

At Block 1230 of FIG. 12, the user 240 closes the template 250 and the web interface 410 sends a command to the file manager 505 to check-in the template 250 so that other users may access it. The file manager 505 receives the request to check-in the template 250 at Block 1235. The file manager 505 then updates the checkout queues, removing the information identifying the user 240 from both the local checkout queue 530 and the checkout queues of the remote file managers 505′ in the remote element management servers 400′. The file manager 505 may also log a record of the transaction.

FIG. 13 is a flowchart illustrating the operation of distributing changes to the network according to embodiments of the present invention, which may correspond to Block 820 of FIG. 8. A file synchronization system, such as the file synchronization system 550 of the file manager 505 in FIG. 5, may be responsible for distributing and synchronizing information between the local and remote element management servers. Referring to FIG. 13, the file synchronization system 550 scans the local template server 510 for file checksums for each template 250 at Block 1305. The file synchronization system 550 also requests file checksums from the remote file managers 505′ in the remote element management systems 400′. The file synchronization system 550 then does a comparison between the information from the local template server 510 and the information received from the remote file managers 505′.

At Block 1310, if the comparison indicates that a template existing in a remote element management server 400′ is not found in the local template server 510, the file synchronization system 550 transfers the missing template from the remote element management server 400′ and updates the local checksum at Block 1315.

If the comparison indicates that all element management servers contain the same templates, the file synchronization system 550 monitors for file checksum mismatches for each template 250 in the local template server 510 at Block 1320. If a checksum mismatch is found, the file synchronization system 550 requests from the remote element management server 400′ when the corresponding template was last modified at Block 1325. This request may be based on the number of seconds since the template was last modified. The file synchronization system 550 then determines at Block 1330 whether the local template 250 is older than the corresponding template stored in the remote element management server 400′. If the template 250 in the local template server 510 is older, the file synchronization system 550 transfers the more recently modified template from the remote element management server 400′ and updates the local checksum at Block 1315. This process is conducted by all element management servers in the network. In this manner, the file synchronization system 550 of the file manager 505 ensures that all servers in the network contain the same information.

FIGS. 14 and 15 are examples of user interfaces according to various embodiments of the present invention. FIG. 14 is an example of a main user interface according to embodiments of the present invention. As illustrated in FIG. 14, the main user interface 1405 includes a system folder holding area 1410, a command holding area 1415, and user holding areas 1420. Each system folder 1425 in the system folder holding area 1410 stores templates corresponding to network elements. The network elements may be grouped according to the organization responsible for their management. The command holding area 1415 provides a list of commands that users may perform on selected network elements. The user holding areas 1420 allow users to customize the main user interface 1405, by editing and/or building their own sub-templates and adding them to the interface 1405. The sub-templates may contain frequently used system folders 1425 or network elements.

FIG. 15 illustrates an example of a device user interface according to embodiments of the present invention. Referring to FIG. 15, the device user interface 1505 displays the network elements 1520 in a matrix 1510, and groups the elements 1520 according to vendor. Each vendor may be assigned a different symbol in the matrix 1510. A user may access the fields and values of the templates for an element by selecting the element from the matrix 1510.

FIGS. 16-20 are examples of templates according to various embodiments of the present invention. FIG. 16 is an example of a search template according to embodiments of the present invention. As shown by FIG. 16, the search template 1605 allows a user to search the network for specific network elements based on values 1610 entered by the user. The search template 1605 is customizable, enabling the user to add 1615 or remove 1620 fields from the template to narrow or broaden the search. The search template 1605 can also be saved, providing users with easy access to frequently used network elements. Results of the search may also be stored in the user holding areas 1420 of FIG. 14.

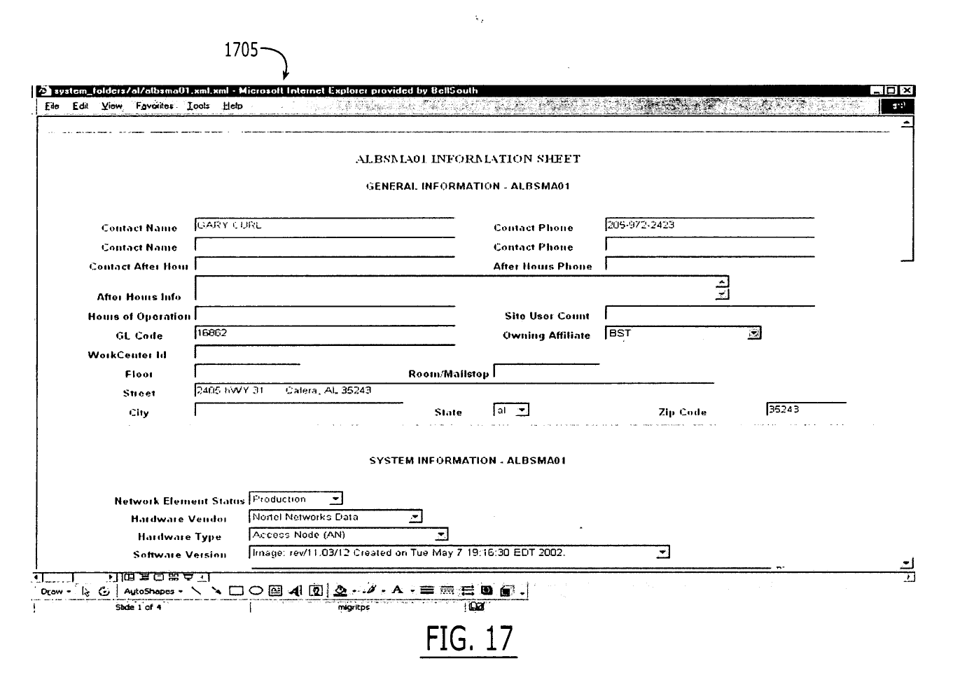

FIG. 17 is an example of a general information template according to embodiments of the present invention. As illustrated in FIG. 17, the general information template 1705 includes contact information for the selected network element, such as contact name, phone number, and after hours information.

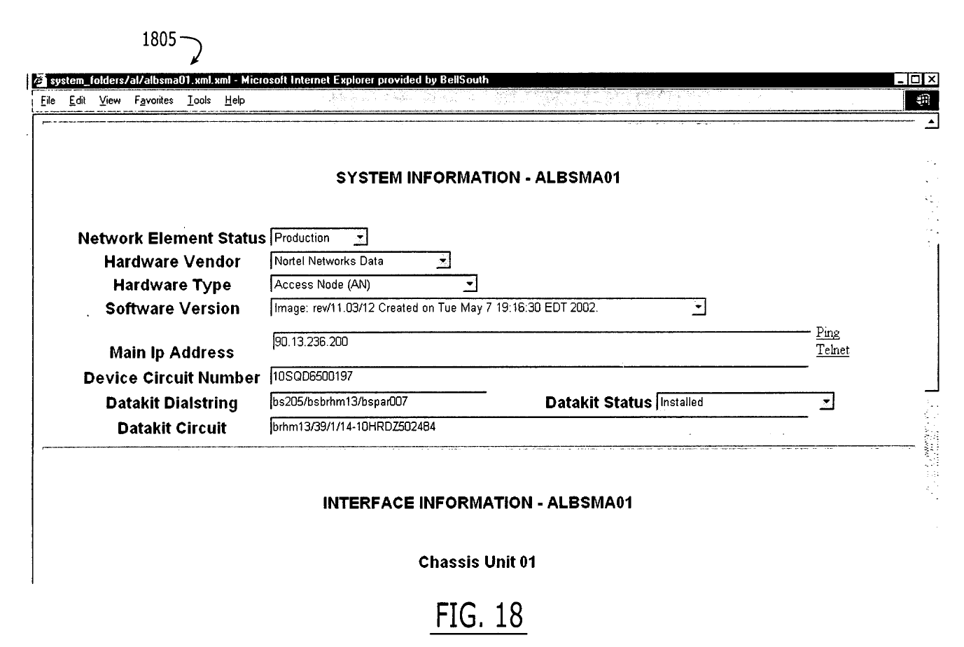

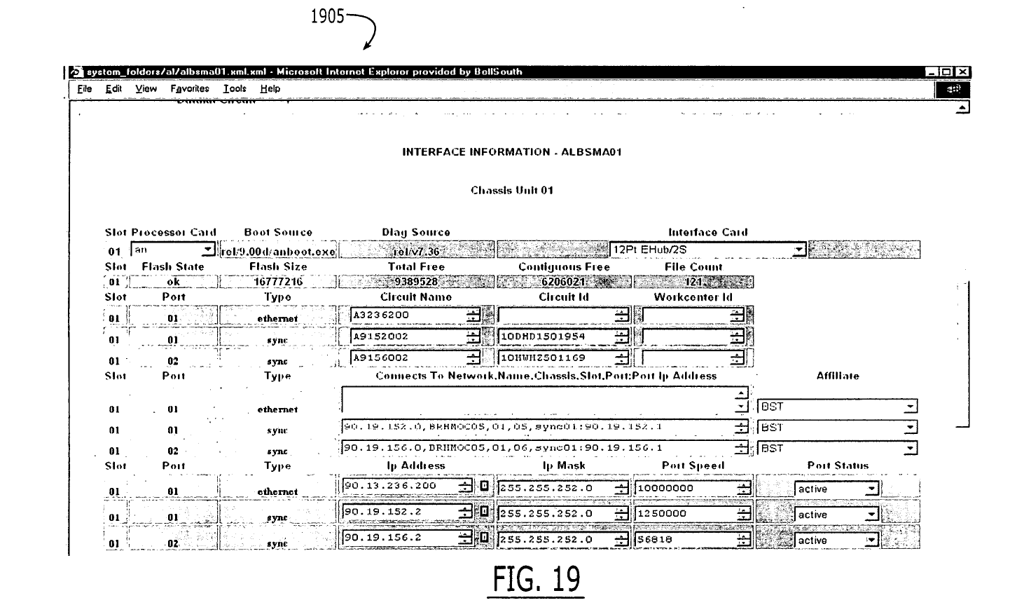

FIG. 18 is an example of a system information template according to embodiments of the present invention. Referring to FIG. 18, the system information template 1805 provides information on element status, hardware vendor and type, software version, and main IP address.

FIG. 19 is an example of an interface template according to embodiments of the present invention. As illustrated in FIG. 19, the interface information template 1905 provides information such as IP address, IP mask, port speed, and port status for the selected network element.

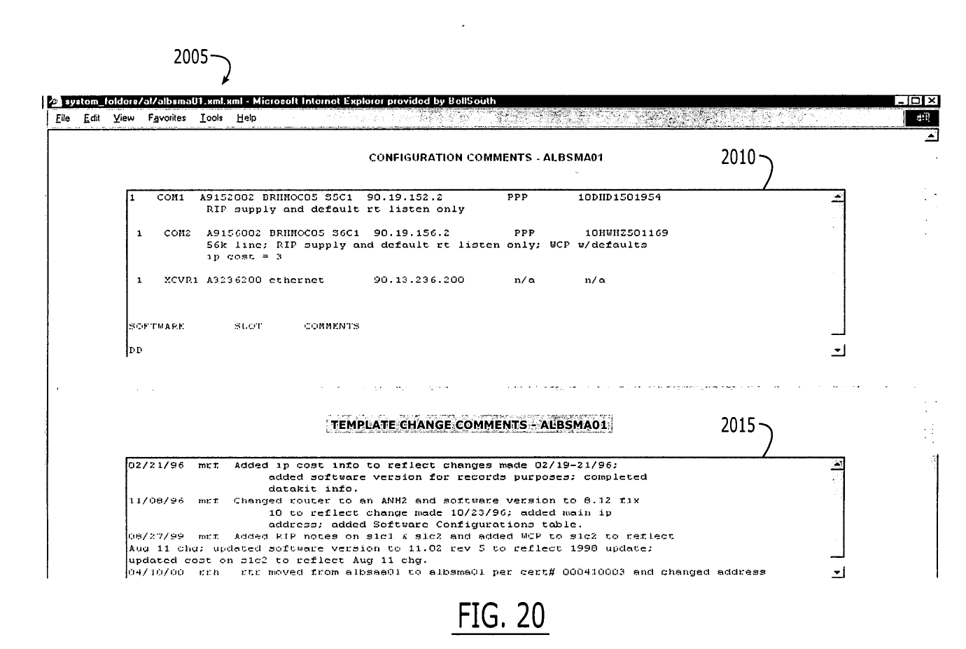

FIG. 20 is an example of another template according to embodiments of the present invention. As shown in FIG. 20, the template 2005 allows a user to add comments regarding changes to the element configuration 2010 and/or changes to the template 2015 for the selected network element.

In the drawings and specification, there have been disclosed embodiments of the invention and, although specific terms are employed, they are used in a generic and descriptive sense only and not for purposes of limitation, the scope of the invention being set forth in the following claims.

1. A method of managing a communications network that includes a plurality of communications network elements comprising:
providing templates that include a plurality of template fields that relate to the plurality of communications network elements and a plurality of predefined values for at least some of the fields; and
allowing user selection of the fields and predefined values to manage the communications network elements.

2. A method according to claim 1 further comprising:
updating the communications network based on the user selection of the fields and predefined values.

3. A method according to claim 2, wherein updating the communications network further comprises:
documenting changes to the fields and predefined values based on the user selection; and
distributing the changes to the communications network.

4. A method according to claim 1 wherein the fields and predefined values of the templates provide system information for the communications network elements.

5. A method according to claim 4 wherein the system information comprises at least one of element status, software version, and vendor information.

6. A method according to claim 1 wherein the fields and predefined values of the templates provide interface information for the communications network elements.

7. A method according to claim 6 wherein the interface information comprises at least one of an IP address, IP mask, port speed, and port status.

8. A method according to claim 1 wherein the fields and predefined values of the templates provide contact information for the communications network elements.

9. A method according to claim 1 wherein the fields and predefined values of the templates provide identification information for the communications network elements.

10. A method according to claim 1 wherein allowing user selection of the fields and predefined values further comprises allowing user customization of the templates to define new fields and new predefined values.

11. A method according to claim 1 wherein the allowing user selection of the fields and predefined values comprises allowing user editing of the fields and predefined values.

12. A method according to claim 1 wherein allowing user selection of the fields and predefined values further comprises allowing user searching of the templates in the communications network.

13. A method according to claim 1 wherein allowing user selection of the fields and predefined values further comprises preventing multiple users from simultaneously accessing the fields and predefined values of a template.

14. A method according to claim 1 wherein allowing user selection of the fields and predefined values further comprises tracking user changes to the fields and predefined values of the templates.

15. A method according to claim 1 wherein allowing user selection of the fields and predefined values is preceded by:
displaying the plurality of communications network elements in a matrix; and
allowing user selection of the communications network elements from the matrix,
wherein allowing user selection of the fields and predefined values comprises allowing user selection based on the user selection of the communications network elements.

16. A method according to claim 2 wherein updating the communications network further comprises configuring the plurality of communications network elements based on the user selection of the fields and predefined values.

17. A method according to claim 1 further comprising archiving current versions of the templates including the fields and predefined values.

18. A method according to claim 10 wherein the allowing user customization further comprises allowing user commentary about the customization.

19. A method according to claim 10 wherein the allowing user customization further comprises allowing users to add sub-templates to the templates, wherein the sub-templates include a plurality of fields and a plurality of predefined values for the fields.

20. A system for managing a communications network that includes a plurality of communications network elements comprising:
a file manager that is configured to provide templates that include a plurality of template fields that relate to the plurality of communications network elements and a plurality of predefined values for at least some of the fields; and
a Web interface that is responsive to the file manager and that is configured to allow user selection of the fields and predefined values to manage the communications network elements.

21. A system according to claim 20 wherein the file manager is further configured to update the communications network based on the user selection of the fields and predefined values.

22. A system according to claim 21 wherein the file manager is configured to update the communications network by documenting changes to the templates based on the user selection of the fields and predefined values and distributing the changes to the communications network.

23. A system according to claim 20 further comprising:
a network manager that is configured to configure the plurality of communications network elements based on the user selection of the fields and predefined values.

24. A system according to claim 20 wherein the file manager is further configured to prevent multiple users from simultaneously accessing the fields and predefined values of a template.

25. A system according to claim 20 wherein the file manager is further configured to archive current versions of the templates including the fields and predefined values.

26. A system according to claim 20 wherein the file manager is further configured to track user changes to the fields and predefined values of the templates.

27. A system according to claim 20 wherein the Web interface is further configured to allow user editing of the fields and predefined values of the templates.

28. A system according to claim 20 wherein the Web interface is further configured to allow user customization of the templates to define new fields and new predefined values.

29. A system according to claim 20 wherein the Web interface is configured to allow user selection of the fields and predefined values by displaying the plurality of communications network elements in a matrix, allowing user selection of the communications network elements from the matrix, and then allowing user selection of the fields and predefined values based on the user selection of the communications network elements.

30. A system according to claim 20 wherein the fields and predefined values of the templates provide at least one of system information, interface information, contact information, and identification information for the network element.

31. A computer program product that is configured to manage a communications network that includes a plurality of communications network elements, the computer program product comprising a computer usable storage medium having computer-readable program code embodied in the medium, the computer-readable program code comprising:
computer-readable program code that is configured to provide templates that include a plurality of fields that relate to the plurality of communications network elements and a plurality of predefined values for at least some of the fields; and
computer-readable program code that is configured to allow user selection of the fields and predefined values to manage the communications network elements.

32. A computer program product according to claim 31 further comprising:
computer-readable program code that is configured to update the communications network based on the user selection of the fields and predefined values.

33. A computer program product according to claim 32 wherein the computer-readable program code that is configured to update the communications network comprises computer-readable program code that is configured to document changes to the fields and predefined values of the templates based on the user selection and distribute the changes to the communications network.

34. A computer program product according to claim 31 further comprising:
computer-readable program code that is configured to archive current versions of the templates including the fields and predefined values.

35. A computer program product according to claim 31 wherein the computer-readable program code that is configured to allow user selection of the fields and predefined values comprises computer-readable program code that is configured to allow user customization of the templates to define new fields and new predefined values.

36. A template that is configured to manage a communications network element in a communications network that includes a plurality of communications network elements, the template comprising:
a plurality of template fields that relate to the communications network element; and
a plurality of predefined values for at least some of the fields.

37. A template according to claim 36, wherein the fields and predefined values of the template provide at least one of system information, interface information, contact information, and identification information for the communications network element.

38. A template according to claim 36, wherein the fields and predefined values of the template are customizable.

39. A template according to claim 36, wherein the fields and predefined values of the template can be edited.

40. A template according to claim 36, wherein the fields and predefined values of the template are not accessible by multiple users at the same time.
